(19) United States
(12) Patent Application Publication
(10) Pub. No.: US 2010/0065676 A1
(43) Pub. Date: Mar. 18, 2010

(54) Balloon kite

(76) Inventor: Kun Yuan Tong, Suwanee, GA (US)

Correspondence Address: Kun Yuan Tong, 2842 Lowe Court, Suwanee, GA, 30024, US

(21) Appl. No.: 12/284,008

(22) Filed: Sep. 17, 2008

(51) Int. Cl. B64C 31/00

(52) U.S. Cl. 244/2

(57) ABSTRACT

To fly kite requires wind and skill. Balloon kite can fly high with no wind. To fly balloon kite requires no skill. You do not have to be an expert to fly balloon kite. In a year only windy season is suitable for flying kite. With balloon kite every day is a flying kite day and every child can fly it. Children can enjoy flying balloon kite all year round.

### THE BACKGROUND OF THE INVENTION

Children like to fly kites. Kite can fly high in the wind. Kite can not fly in very light wind. In a year some season has suitable wind to fly kite and some season does not suitable wind to fly kite. Therefore flying kite is a seasonal game. The present invented balloon kite has filled up with hydrogen gases or helium gases and can fly high without wind. Children can fly balloon kite all year round.

### THE BRIEF DESCRIPTION OF THE INVENTION

Balloon kite has a built-in airtight gas chamber to fill up with hydrogen or helium gases or has a built-in pouch to store a balloon so it can float in air. Children can fly balloon kite without wind all year round.

### THE DETAILED DESCRIPTION OF THE INVENTION

FIG. 1 is a perspective view of balloon kite which has a built-in airtight gas chamber to fill up with hydrogen or helium gases.

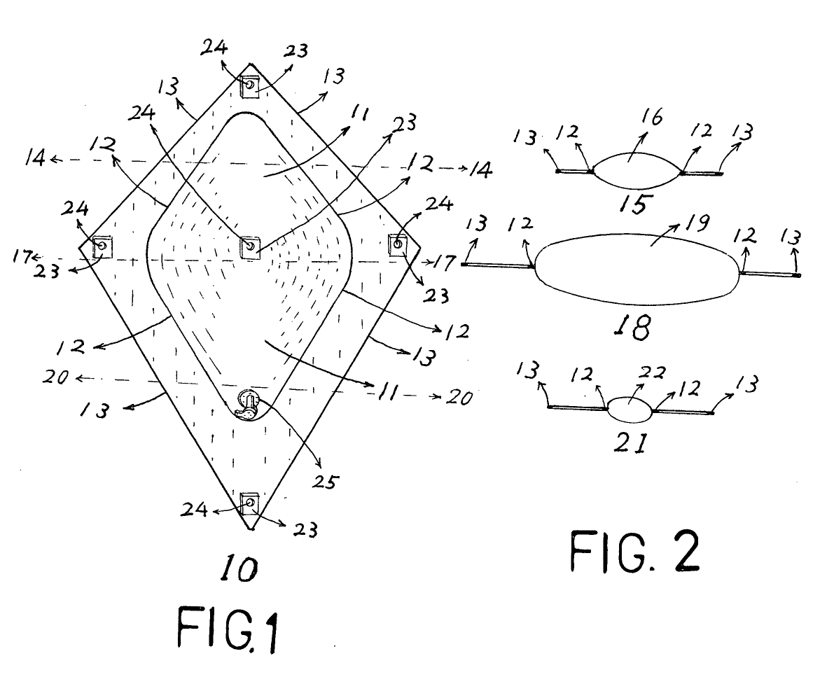

FIG. 2 is the dissection view of balloon kite at the dissection lines 14, 15 and 16.

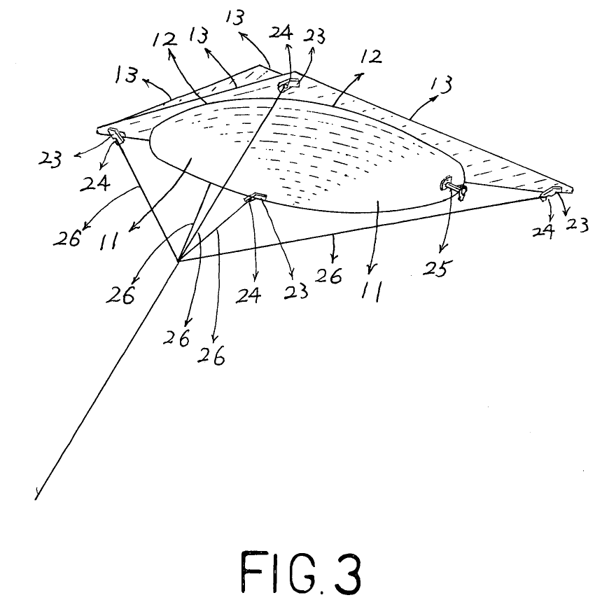

FIG. 3 is lateral view of balloon kite which has a built-in airtight gas chamber which is filled up with hydrogen or helium gases and is tied by strings.

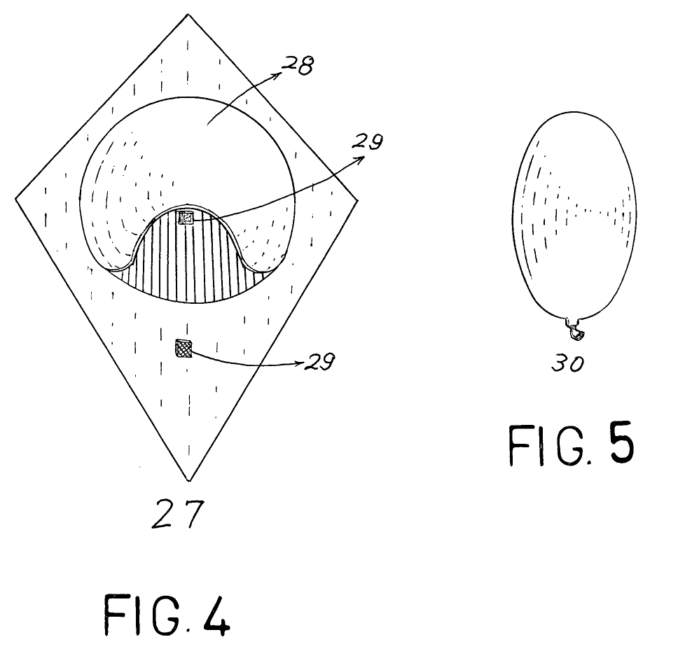

FIG. 4 is a perspective view of balloon kite which has a built-in pouch to store a balloon.

FIG. 5 is a perspective view of a balloon.

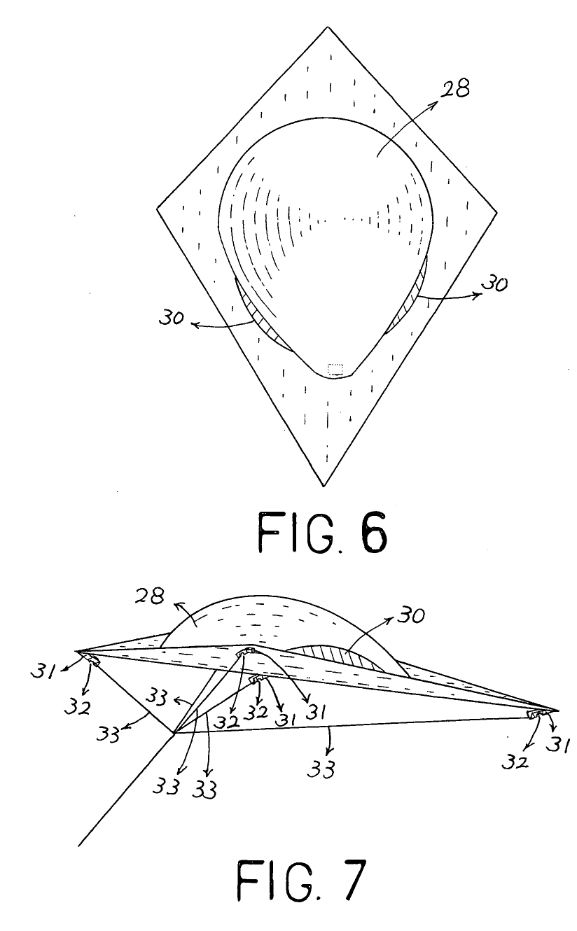

FIG. 6 is perspective view of balloon kite which has a built-in pouch and a balloon which is stored inside the built-in pouch.

FIG. 7 is a lateral view of kite which has a built-in pouch and a balloon which is stored inside the built-in pouch and is tied with strings.

### THE DETAILED DESCRIPTION OF THE INVENTION

Referring now in detail to the drawings numeral 10 of FIG. 1 is balloon kite which is made of plastic or other materials. Numeral 11 of FIGS. 1 and 3 is balloon. Numeral 12 of FIGS. 1, 2 and 3 is heat-sealed line of balloon. Numeral 13 of FIGS. 1, 2 and 3 is heat-sealed line of balloon kite 10. Numeral 14 is the dissection line at the front portion of balloon kite 10. Numeral 15 of FIG. 2 is the dissection view of balloon kite 10 along the dissection line 14. Numeral 16 of FIG. 2 is gas chamber of balloon kite 10. Numeral 17 of FIG. 1 is the dissection line at the middle of balloon kite 10. Numeral 18 of FIG. 2 is the dissection view of balloon kite 10 along the dissection line 17. Numeral 19 of FIG. 2 is gas chamber of balloon kite 10. Numeral 20 of FIG. 1 is the dissection line at the posterior portion of balloon kite 10. Numeral 21 of FIG. 2 is the dissection view of balloon kite 10 along the dissection line 20. Numeral 22 of FIG. 2 is gas chamber of balloon kite 10. Numeral 23 of FIGS. 1 and 3 is fenestrated anchor that is fixed onto each corner of balloon kite 10 and the center of the bottom of balloon 11. Numeral 24 of FIGS. 1 and 2 is the hole of fenestrated anchor 23. Numeral 25 of FIGS. 1 and 3 is inflation unit. Hydrogen or helium gas is inflated into gas chamber 11 through inflation unit 25. Numeral 26 of FIG. 3 is string which fastens balloon kite 10 at the hole 24 of each anchor 23. Numeral 27 of FIG. 4 is another version of balloon kite which has a built-in pouch 28 and a balloon 30 which is stored inside pouch 28. Numeral 28 of FIGS. 4, 6 and 7 is built-in pouch. Numeral 29 of FIG. 4 is Velcro for closing pouch 28. Numeral 30 of FIGS. 5, 6 and 7 is a balloon. Pouch 28 is very large and can store balloon 30. Numeral 31 of FIG. 7 is fastener. Numeral 32 of FIG. 7 is the hole of fastener 31. Numeral 33 is string which fastens balloon kite 27 at each hole 32 of fastener 31.

1. Balloon kite comprising a kite and a balloon.

2. Balloon kite of claim 1 wherein the said kite has a built-in airtight gas chamber and the said balloon is the said built-in airtight gas chamber which is filled up with hydrogen or helium gases.

3. Balloon kite of claim 1 wherein the said kite has a built-in pouch to store the said balloon and the said balloon is a balloon which is to be stored inside the said built-in pouch.
